(19) United States
(12) Patent Application Publication
(10) Pub. No.: US 2015/0332279 A1
(43) Pub. Date: Nov. 19, 2015

(54) REAL-TIME REMOTE AUDITING

(71) Applicant: International Business Machines Corporation, Armonk, NY (US)

(72) Inventors: Alexander G. Garrido, Mexico (PH); Michael Russell U. Gonzales, Lucena City (PH); Eun D. Kim, Seoul (KR); Mark T.W. Lam, Singapore (SG); Ooi T. Ong, Singapore (SG)

(21) Appl. No.: 14/514,706

(22) Filed: Oct. 15, 2014

Related U.S. Application Data
(63) Continuation of application No. 14/278,523, filed on May 15, 2014.

(51) Int. Cl. G06Q 30/00; H04N 5/232

(52) U.S. Cl. CPC G06Q 30/018; H04N 5/23229

(57) ABSTRACT

In one embodiment, an instruction from an auditor to capture an image of an object is received. The image of the object is captured. The captured image of the object is transmitted in real-time to the auditor for viewing and/or verification that the captured image satisfies the instruction. The instruction and/or the object are associated with an audit.

### BACKGROUND

The present disclosure relates generally to the field of enterprise management systems, and more particularly to real-time remote auditing. Audits are planned and documented activities performed by qualified personnel to determine by investigation, examination, or evaluation of objective evidence, the adequacy and compliance with established procedures, or applicable documents, and the effectiveness of implementation. Audits, such as quality audits, are performed to verify conformance to standards through review of objective evidence.

For example, the International Organization for Standards (ISO) is an international standard-setting body composed of representatives from various national standards organizations. ISO 9000 is a series of standards, developed and published by ISO, that define, establish, and maintain an effective quality assurance system for manufacturing and service industries. ISO deals with the fundamentals of quality management systems, including eight management principles upon which the family of standards is based. For example, ISO 9001 deals with the requirements that organizations wishing to meet the standard must fulfill and is a widely used management tool. Before the certification body can issue or renew a certificate, the auditor must be satisfied that the company being assessed has implemented the requirements of, for example, sections 4 through 8 of ISO 9001. Certification is a written assurance that the product, service, or system in question meets specific standards, such as ISO management system standards. Auditing typically requires the auditor to physically be at the audit site for the duration of the audit.

### SUMMARY

In one embodiment, an instruction from an auditor to capture an image of an object is received. The image of the object is captured. The captured image of the object is transmitted in real-time to the auditor for viewing and/or verification that the captured image satisfies the instruction. The instruction and/or the object are associated with an audit.

### BRIEF DESCRIPTION OF THE SEVERAL VIEWS OF THE DRAWINGS

FIG. 1 is a block diagram illustrating an environment, in accordance with an embodiment of the present invention.

FIG. 2 is a depiction of various transmissions between the computing devices of FIG. 1, in accordance with an embodiment of the present invention.

FIG. 3 illustrates operational steps of a program function, in accordance with an embodiment of the present invention.

FIG. 4 depicts a block diagram of components of the computing device executing the program function, in accordance with an embodiment of the present invention.

### DETAILED DESCRIPTION

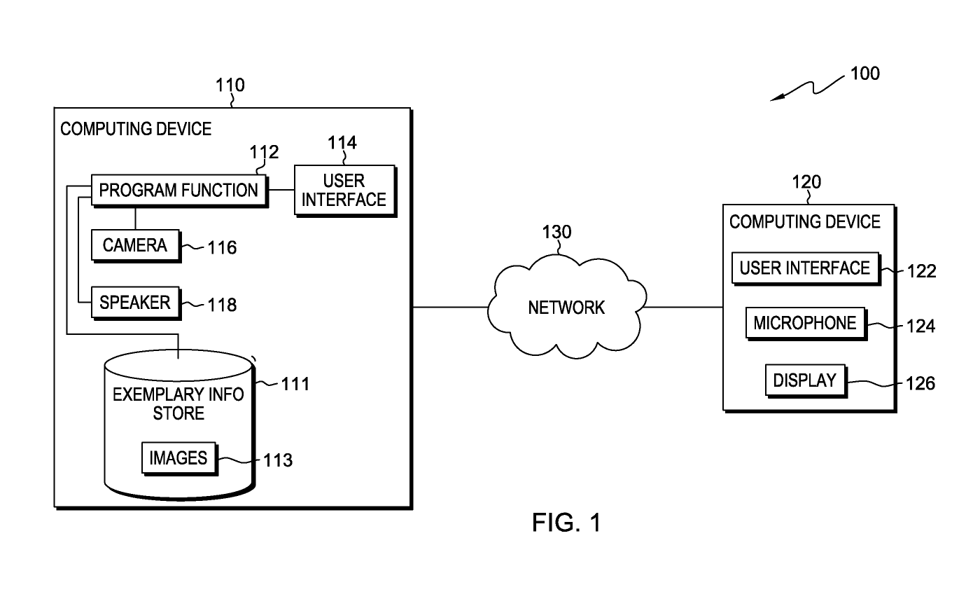

With reference now to FIGS. 1-4.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java™ Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Audits are planned and documented activities performed by qualified personnel to determine by investigation, examination, or evaluation of objective evidence, the adequacy and compliance with established procedures, or applicable documents, and the effectiveness of implementation. Audits, such as quality audits, are performed to verify conformance to standards, such as International Organization for Standards (ISO) 9000. ISO is an international standard-setting body composed of representatives from various national standards organizations. For example, ISO 9000 is a series of standards, developed and published by the ISO, that define, establish, and maintain an effective quality assurance system for manufacturing and service industries. ISO deals with the fundamentals of quality management systems, including eight management principles upon which the family of standards is based.

ISO 9001 deals with the requirements that organizations wishing to meet the standard must fulfill and is a widely used management tool. Before the certification body can issue or renew a certificate, the auditor must be satisfied that the company, site, or department being assessed has implemented the requirements of, for example, sections 4 through 8 of ISO 9001. Certification is a written assurance that the product, service, or system in question meets specific requirements, such as ISO management system standards. There are typically two compliance statuses, compliant and non-compliant, wherein an entity may only achieve a compliant status as a result of adhering to a predetermined percentage of the specified requirements. Cost challenges can impede the ability of a company to perform an audit at a distant site. Certain aspects of the present invention seek to facilitate the remote auditing of a facility, site, or desired location. An auditee utilizes a computing device having internet connectivity capabilities that comprises a camera and speaker to address auditor question and/or instructions. Using the applicable standards, such as ISO 9001, an auditor transmits to an auditee audit-related questions and/or instructions that typically involve the need for the auditee to capture images and/or videos of audit-related objects and transfer the captured images and/or videos to the auditor in real-time for viewing and/or storage thereby allowing the auditee to address audit-related questions.

Embodiments of the present invention will now be described in detail with reference to the Figures. FIG. 1 is a block diagram illustrating an environment, generally designated 100, in accordance with one embodiment of the present invention.

Environment 100 includes computing devices 120 and 110, all interconnected over network 130. Network 130 can be, for example, a local area network (LAN), a wide area network (WAN), such as the Internet, or a combination of the two, and can include wired, wireless, or fiber optic connections. Network 130 may be a distributed computing environment utilizing clustered computers and components that act as a single pool of seamless resources, as is common in data centers and with cloud computing applications or “clouds”. In general, network 130 can be any combination of connections and protocols that will support communications between computing devices 120 and 110.

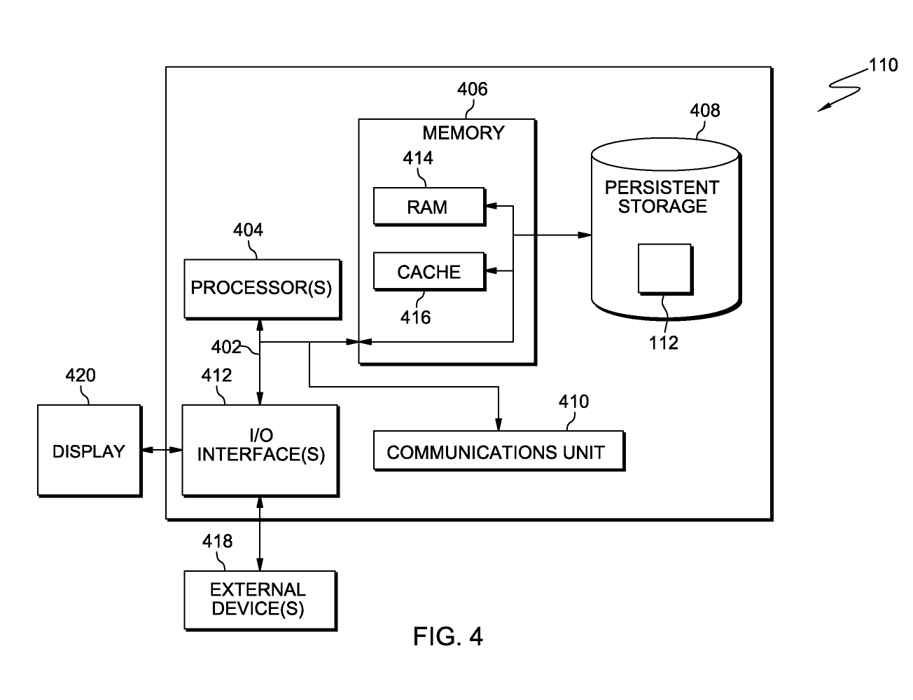

In various embodiments of the present invention, computing devices 120 and 110 may each be a laptop computer, a tablet computer, a netbook computer, a personal computer (PC), a desktop computer, a personal digital assistant (PDA), a smart phone, or any programmable electronic device capable of communicating via network 130. Computing device 120 is a computing device that is utilized by an auditor to communicate with an auditee to conduct an audit, in accordance with an embodiment of the present invention. In certain embodiments, the audit complies at least partially with one or more of an ISO standard, an International Electronic Commission (IEC) standard, a Good Laboratory Protocol standard, and a good Manufacturing Protocol standard. Computing device 120 includes display 126, microphone 124, and user interface 122, in accordance with an embodiment of the present invention. In other embodiments, display 126 is display 420 of FIG. 4 (discussed below). Display 126 allows the auditor to view and/or verify the images and videos transmitted to computing device 120 via network 130, for example, images and videos transmitted by computing device 110.

In other embodiments, display 126 is a touch screen display. Microphone 124 can use electromagnetic induction, capacitance change, or piezoelectric generation to produce an electrical signal from air pressure vibrations. User interface 122 is a text-based or graphics-based user interface that allows a user, such as an auditor, of computing device 120 to generate and/or transmit, via network 130, questions and/or instructions, for example, audit-related instructions, to program function 112 via computing device 110.

Computing device 110 is a computing device that is used by an auditee to participate in remote audits, in accordance with an embodiment of the present invention. Computing device 110 comprises program function 112, user interface 114, camera 116, speaker 118, and exemplary information store 111. Although not shown, computing device 110 may also include a microphone for communication with, for example, the user of computing device 120. Program function 112 is software that facilitates remote auditing of a facility, in accordance with an embodiment of the present invention. Program function 112 is in communication with user interface 114, camera 116, speaker 118, and exemplary information store 111, in accordance with an embodiment of the present invention.

User interface 114 is a text-based or graphics-based user interface that allows a user, such as an auditee, of computing device 110 to interact with program function 112 and electronic components attached thereto to participate in an audit. Camera 116 encodes digital images and/or videos and stores them in, for example, images 113 (discussed below). In an embodiment, camera 116 is not included in computing device 110 and communicates with program function 112 via network 130. Exemplary information store 111 is an information repository that includes images 113. In an embodiment, images and/or videos generated by camera 116 include one or more of an audit objectID, audit object location, temperature, time, audit date, and audit object installation date. For example, an objectID identifies the audit-related object, such as item # ABC123XYZ. In certain embodiments, camera 116 generates digital images and/or video having a resolution of at least 480 horizontal scan lines.

Generally, images having a resolution of 720 or more horizontal scan lines are considered high-definition. In other embodiments, camera 116 generates digital images and/or video having a capture rate of at least fifty frames per second. In additional embodiments, camera 116 is an attachable camera, a finger-wearable camera, a power camera, and/or a rotatable camera with speaker capabilities. In certain embodiments, camera 116 captures images and/or video using a macroscopic or microscopic vision mode. The macroscopic scale refers to the length scale on which objects or phenomena are large enough to be visible with the unaided eye, such as without magnifying devices. The microscopic scale refers to the scale of objects and events smaller than those that can easily be seen by the naked eye, requiring a lens or microscope to see them clearly.

Camera 116 can capture images for real-time transmission to an auditor, for example, the user of computer device 120. Speaker 118 allows the user of computing device 110, for example, the auditee, to hear audit-related questions and/or instructions generated by the user of computing device 120, for example, the auditor. Program function 112 receives audit-related questions and/or instructions from, for example, an auditor. Program function 112 can transmit images captured by camera 116 to computing device 120 via network 130.

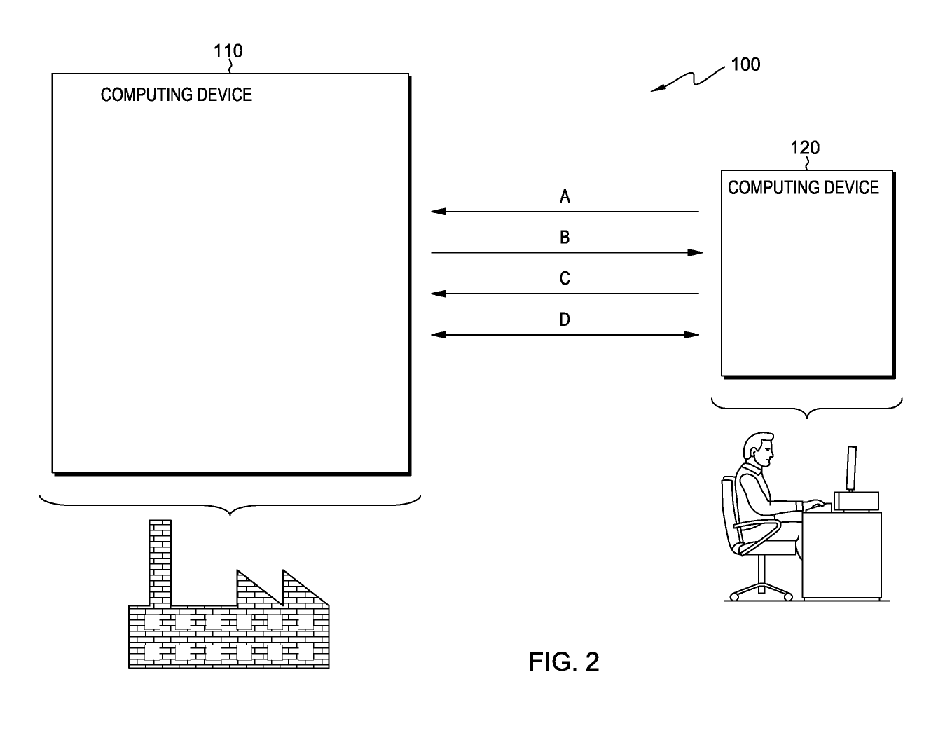

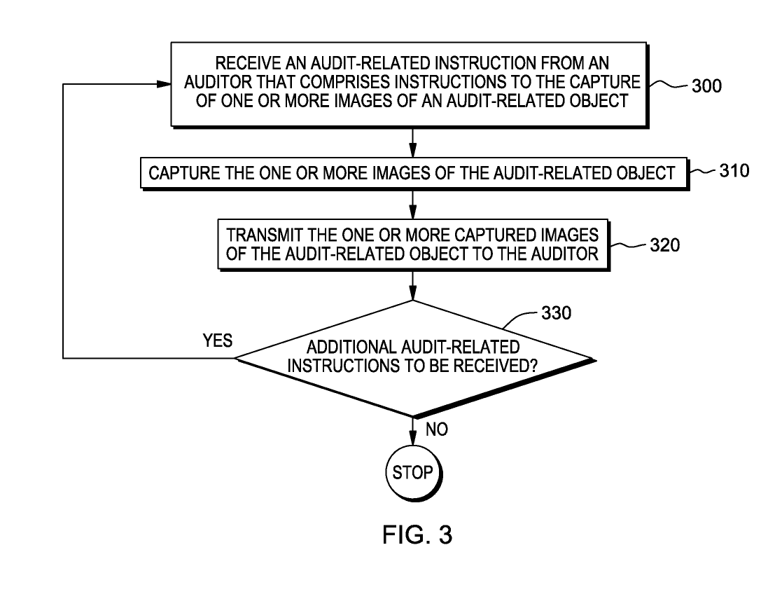

Concepts introduced in the following discussion of FIG. 2 will be used further in the discussion of FIG. 3 in the context of environment 100 of FIG. 1. Specifically, FIG. 2 illustrates an embodiment of the present invention wherein verbal audit-related instructions are transmitted from an auditor to an auditee during a remote audit, wherein the auditee executes the instructions and transmits the results to the auditor for viewing and/or verification that the results are compliant. For example, the auditor (Auditor) and the auditee (Auditee) are the users of computing devices 120 and 110, respectively. Auditor desires to conduct a remote audit of factory site B, which is located in the country of Singapore, while remaining in her office, which is located in the United States.

Program function 112 can facilitate remote auditing by allowing one or more auditors to communicate audit-related questions and/or instructions electronically to one or more auditees. FIG. 2 is a depiction of various transmissions between the computing devices of FIG. 1, in accordance with an embodiment of the present invention. In particular, Auditor desires to know the current temperature and humidity of a reflow room located at factory site B. Auditor transmits the instruction, “Please, record the temperature and humidity of the reflow room located at factory site B?” to Auditee using transmission A. Computing device 110 receives transmission A and Auditee listens to the received instructions via speaker 118. Using camera 116, Auditee captures one or images of the thermometers and hygrometers that monitor the reflow room at factory site B. Auditee transmits the captured one or more images to Auditor via transmission B for viewing and verification that the one or more images are compliant.

In transmission C, Auditor again uses microphone 124 and asks Auditee, “Please take a picture of the machine calibration and maintenance records that are associated with the thermometer and hygrometer?” Auditee receives the instruction via speaker 118, and when she arrives at the appropriate location holding the records, Auditee orients camera 116 to the location of the machine calibration and maintenance records and captures one or more images thereof and, via transmission D, transmits the one or more captured images to Auditor for viewing and verification that the one or more captured images are compliant. Auditor receives the information that is included in transmission D and, satisfied with the response, concludes the audit. Although not shown, applicable audits can include transmissions in addition to those depicted.

FIG. 3 is a flowchart depicting operational steps of program function 112, in accordance with an embodiment of the present invention. Program function 112 receives instructions from an auditor that comprises instructions to capture one or more images of an audit-related object (step 300). Program function 112 captures the one or more images of the audit-related object (step 310). Program function 112 transmits the captured one or more images of the audit-related object to the auditor (step 320). Program function 112 determines whether there are additional audit-related instructions to be received (decisional 330). If program function 112 determines there are additional audit-related instructions to be received (“yes” branch decisional 330), then program function 112 returns to step 300. If program function 112 determines there are no additional audit-related instructions to be received (“no” branch decisional 330), then program function 112 stops.

FIG. 4 depicts a block diagram of components of computing device 110 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

A non-transitory computer readable storage medium embodiment herein is readable by a computerized device. The non-transitory computer readable storage medium stores instructions executable by the computerized device to perform a method that tests integrated circuit devices to measure a voltage overshoot condition.

Computing device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Program function 112 is stored in persistent storage 408 for execution by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of computing device 120. In these examples, communications unit 410 includes one or more network interface cards. Communications unit 410 may provide communications through the use of either or both physical and wireless communications links. Program function 112 may be downloaded to persistent storage 408 through communications unit 410.

I/O interface(s) 412 allows for input and output of data with other devices that may be connected to server computer 102. For example, I/O interface(s) 412 may provide a connection to external device(s) 418 such as a keyboard, a keypad, a touch screen, and/or some other suitable input device. External device(s) 418 can also include portable computer readable storage media such as, for example, thumb drives, portable optical or magnetic disks, and memory cards. Software and data used to practice embodiments of the present invention, e.g., program function 112, can be stored on such portable computer readable storage media and can be loaded onto persistent storage 408 via I/O interface(s) 412. I/O interface(s) 412 also connects to a display 420. Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

What is claimed is:

1. A method comprising:
receiving, by one or more computer processors, an instruction from an auditor to capture an image of an object;
capturing, by one or more computer processors, the image of the object;
transmitting, by one or more computer processors, the image of the object in real-time to the auditor for viewing and/or verification that the image of the object satisfies the instruction; and
wherein one or more of the instruction and the object are associated with an audit.

2. The method of claim 1, wherein the captured image includes one or more of an objectID, an object location, a temperature, a time, an audit date, and an object installation date.

3. The method of claim 1, wherein the step of transmitting, by the one or more computer processors, the image of the object comprises transmitting, by one or more computer processors, a compliance status of the object.

4. The method of claim 1, wherein the audit at least partially complies with one or more of an International Organization for Standardization standard, a Good Manufacturing Practice standard, a Good Laboratory Practice standard, a Good Clinical Practice standard, or an International Electrotechnical Commission standard.

5. The method of claim 1, wherein the instruction includes a verbal instruction and/or a text-based instruction.

6. The method of claim 1, wherein the image of the object has a resolution of at least 720 horizontal scan lines.

7. The method of claim 1, wherein the image is a video having one or more of a resolution of at least 480 horizontal scan lines and a resolution capture rate of at least fifty frames per second.
